(19) United States
(12) Patent Application Publication
(10) Pub. No.: US 2017/0115433 A1
(43) Pub. Date: Apr. 27, 2017

(54) MULTILAYER OPTICAL SHEET ASSEMBLY

(71) Applicant: SANGBO CORPORATION, Gyeonggi-do (KR)

(72) Inventors: SANG GUN KIM, Gyeonggi-do (KR); YONG WAN PARK, Gyeonggi-do (KR); YOUNG GIL MYOUNG, Seoul (KR); SUNG OH KWON, Gyeonggi-do (KR); JAE HWAN YEON, Incheon (KR); TAE HWA KIM, Seoul (KR)

(21) Appl. No.: 15/298,978

(22) Filed: Oct. 20, 2016

(30) Foreign Application Priority Data
Oct. 21, 2015 (KR) 10-2015-0146767
Aug. 2, 2016 (KR) 10-2016-0098536

(51) Int. Cl. G02B 5/02; B32B 3/30; G02B 5/04; B32B 7/12

(52) U.S. Cl. CPC G02B 5/0268; B32B 7/12; B32B 3/30; G02B 5/045; G02B 5/0242; G02B 5/0221; B32B 2307/40

(57) ABSTRACT

An optical sheet assembly. A first base film has a first pattern layer disposed thereon. A second base film is disposed on one surface of the first base film and has a second pattern layer disposed on a top surface thereof. The second pattern layer abuts and supports a bottom surface of the first base film. A third base film is disposed on one surface of the second base film and has light-scattering beads being contained therein and recesses formed in one surface thereof bonded to the second base film. The second pattern layer is oriented in the same direction as the first pattern layer. The diameters of the recesses are greater than diameters of entrances thereof. Each of the first pattern layer and the second pattern layer includes a plurality of protrusions and a plurality of recesses defined between the protrusions.

### CROSS-REFERENCE TO RELATED APPLICATION

This application is based on and claims priority from Korean Patent Application No. 10-2015-0146767 filed on Oct. 21, 2015 and Korean Patent Application No. 10-2016-0098536 filed on Aug. 2, 2016 in the Korean Intellectual Property Office, the disclosure of which is incorporated herein in its entirety by reference.

### BACKGROUND OF THE INVENTION

Field of the Invention

The present invention relates, in general, to an optical sheet assembly and, more particularly, to an optical sheet assembly comprised of multilayers of a prism sheet having regular pitches, a prism sheet having variable pitches, and diffusing means, the prism sheets and the diffusing means being stacked on one another to improve optical modulation and optical diffusion.

Description of the Related Art

In general, liquid crystal display (LCD) devices display image information using white light supplied by backlight units (BLUs) disposed in the rear thereof.

Such a backlight unit includes a light source, a light guide plate (LGP), a reflector, and an optical sheet.

The optical sheet is comprised of a base layer, a prism sheet, and a protective sheet, the base layer, the prism sheet, and the protective sheet being stacked sequentially on one another.

The base layer serves to scatter light that has been emitted from the light guide plate and has entered a display section (not shown), thereby making the brightness distribution of light uniform.

The prism sheet has prisms having triangular cross-sections, the prisms being repeatedly formed on the top surface. The prism sheet serves to condense light that has been diffused by the base layer in the direction perpendicular to the plane of the display section, thereby increasing brightness.

Thus, the most light that has passed through the prism sheet comes to travel in the direction parallel to the plane of the display section (not shown), thereby forming uniform brightness distribution.

Korean Patent Application No. 10-2013-0168974, titled “COMPOSITE OPTICAL SHEET, METHOD OF FABRICATING THE SAME, AND LIGHT SOURCE ASSEMBLY INCLUDING THE SAME,” has been disclosed.

Describing the related-art patent document briefly, the composite optical sheet includes a base, a light blocking layer disposed on the bottom layer of the base and including a binder and organic particles and inorganic particles dispersed in the binder, a first optical pattern layer disposed on the top surface of the base and including concave and convex portions, and a second optical pattern layer disposed on and bonded to the first optical pattern layer, the convex portions of the first optical pattern layer being fitted into or fused to the bottom surface of the second pattern layer. The composite optical sheet further includes a lower-refractivity area between the bottom surface of the second optical pattern layer and the concave portions of the first optical pattern layer, the refractive index of the lower-refractivity area being lower than the refractive index of the second optical pattern layer.

According to the related-art patent document, however, fabrication costs are expensive due to the thick optical sheet and complicated fabrication processing. In addition, improvements in the brightness thereof are required since the optical modulation thereof is unsatisfactory.

The information disclosed in the Background of the Invention section is only for the enhancement of understanding of the background of the invention, and should not be taken as an acknowledgment or as any form of suggestion that this information forms a prior art that would already be known to a person skilled in the art.

### RELATED ART DOCUMENT

Patent Document 1: Korean Patent Application No. 10-2013-0168974

### SUMMARY OF THE INVENTION

Accordingly, the present invention has been made keeping in mind the above problems occurring in the related art, and the present invention is intended to propose an optical sheet assembly in which dual layers of prism sheets able to improve a light-diffusing function and a light modulation characteristic are formed and a diffusion sheet able to diffuse light is formed on one side.

Also provided is an optical sheet assembly, in which pattern layers having the shape of concave and convex portions are machined in the top surfaces of first and second base films having the shape of dual layers, such that a light-diffusing effect can be obtained without a light-diffusing layer in which a light-diffusing agent is contained. This can consequently reduce the number of components while reducing the thickness of the multilayer optical films. In addition, the recesses having diameters greater than the diameters of the entrances are formed in the third base film, thereby being able to prevent or reduce sparkling.

In order to achieve the above object, according to one aspect of the present invention, an optical sheet assembly may include: a first base film having a first pattern layer disposed thereon; a second base film disposed on one surface of the first base film, the second base film having a second pattern layer disposed on a top surface thereof, the second pattern layer abutting and supporting a bottom surface of the first base film; and a third base film disposed on one surface of the second base film, the third base film having light-scattering beads being contained therein and recesses formed in one surface thereof bonded to the second base film, wherein the second pattern layer is oriented in the same direction as the first pattern layer, and wherein diameters of the recesses are greater than diameters of entrances thereof. Each of the first pattern layer and the second pattern layer may include a plurality of protrusions and a plurality of recesses defined between the protrusions. The second pattern layer may include first protrusions abutting to and supporting the first base film, second protrusions, heights of which are smaller than heights of the first protrusions, and recesses defined between the first protrusions and the second protrusions.

Top ends of the second protrusions of the second patter layer may be spaced apart from a bottom portion of the first base film.

The third base film may include a diffusion layer on one surface thereof, the diffusion layer diffusing light before the light enters the second base film.

The diffusion layer may include a binder resin and beads contained in the binder resin.

The third base film may include a bead coating layer formed on the other surface thereof.

According to embodiments of the present invention, in the optical sheet, the pattern layers having the shape of concave and convex portions are machined in the top surfaces of the first and second base films having the shape of dual layers, such that a light-diffusing effect can be obtained without a light-diffusing layer in which a light-diffusing agent is contained. This can consequently reduce the number of components while reducing the thickness of the multilayer optical films.

In addition, the recesses having diameters greater than the diameters of the entrances are formed in the third base film, thereby being able to prevent or reduce sparkling.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating an optical sheet assembly according to an exemplary embodiment of the present invention;

FIG. 2 is a cross-sectional view illustrating the optical sheet assembly according to the exemplary embodiment of the present invention;

FIGS. 3 and 4 are perspective views illustrating implementations of the first pattern layer in the optical sheet assembly according to the exemplary embodiment of the present invention;

FIGS. 5 and 6 are perspective views illustrating implementations of the second pattern layer in the optical sheet assembly according to the exemplary embodiment of the present invention;

FIG. 7 is an enlarged cross-sectional view illustrating an important part of another implementation of the second pattern layer in the optical sheet assembly according to the exemplary embodiment of the present invention;

FIG. 8 is a tomographic image illustrating an optical sheet according to a comparative example;

FIG. 9 is a tomographic image illustrating an optical sheet according to an example of the present invention;

FIG. 10 is an image illustrating sparkling formed by a UV adhesive during the process of fabricating an optical sheet assembly; and

FIGS. 11A and 11B are SEM images of sparkling occurring in an optical sheet assembly according to Example 1 of the present invention and an optical sheet assembly according to Comparative Example 1.

### DETAILED DESCRIPTION OF THE INVENTION

Reference will now be made in greater detail to an exemplary embodiment of the present invention, an example of which is illustrated in the accompanying drawings.

The following exemplary embodiments will be described in detail so that a person skilled in the art to which the present invention relates could easily put the present invention into practice. However, the principle and scope of the present invention should not be understood to be limited thereto.

In addition, the sizes or shapes of components illustrated on the drawings may be rather exaggerated for the sake of clearness and convenience of explanation. Terms specifically defined herein may be understood differently depending on the users, the intention of the users, practices, or the like, since they are defined considering the configurations and functions thereof in the present invention. Thus, these terms shall be defined to be consistent with their meaning in the context of the specification

In addition, all terms used herein may be understood differently depending on the users, the intention of the users, practices, and the like, since they are defined considering the functions thereof in the present invention. Thus, these terms shall be defined to be consistent with their meaning in the context of the specification.

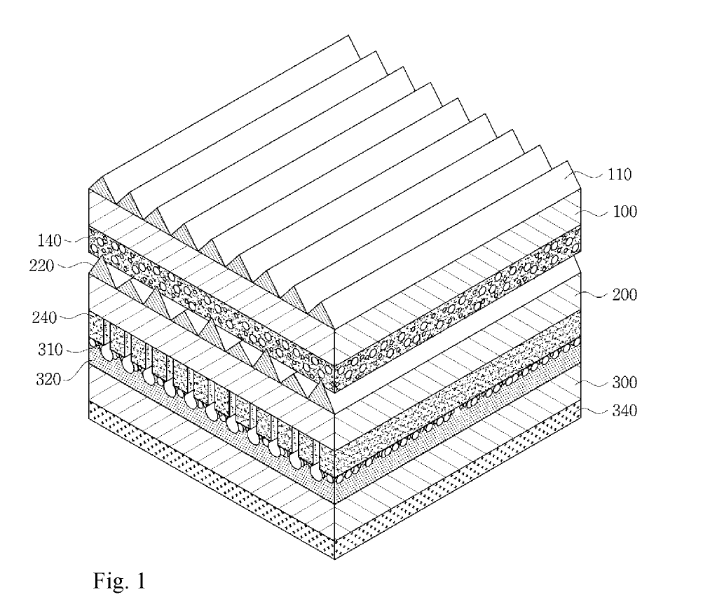

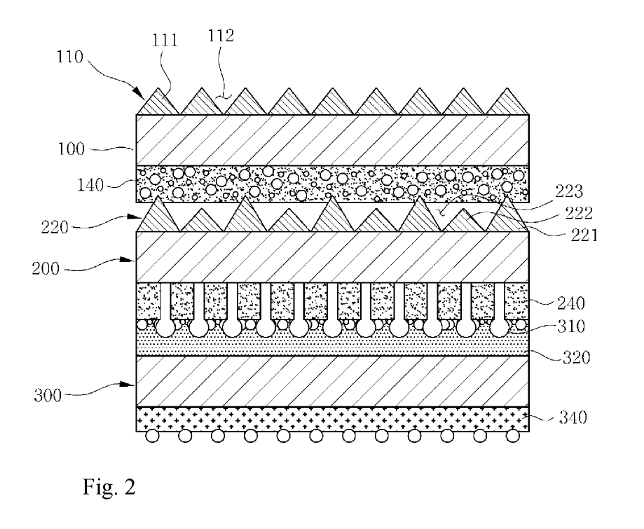

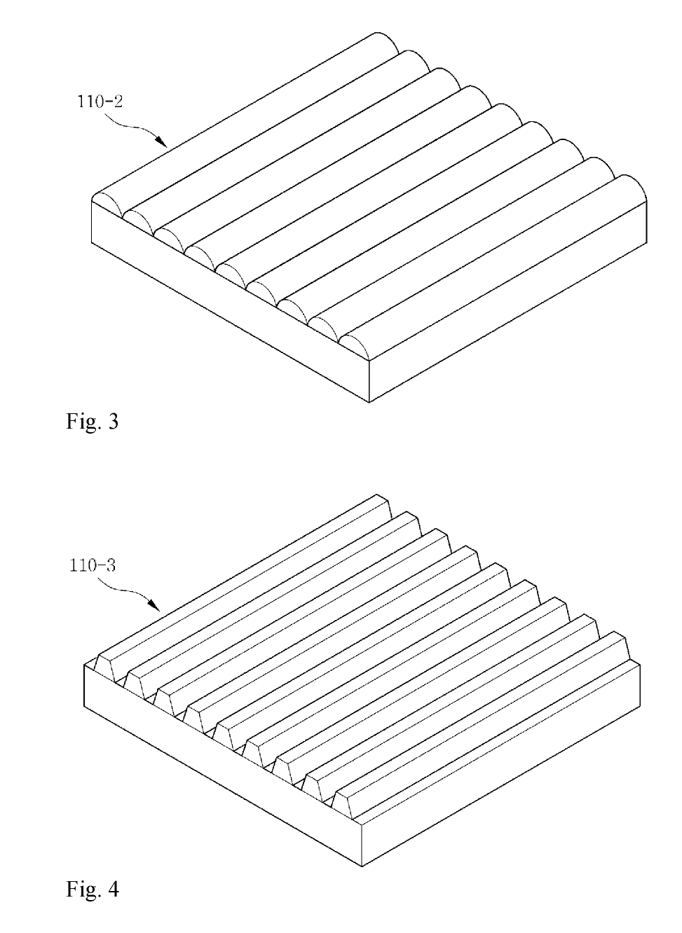

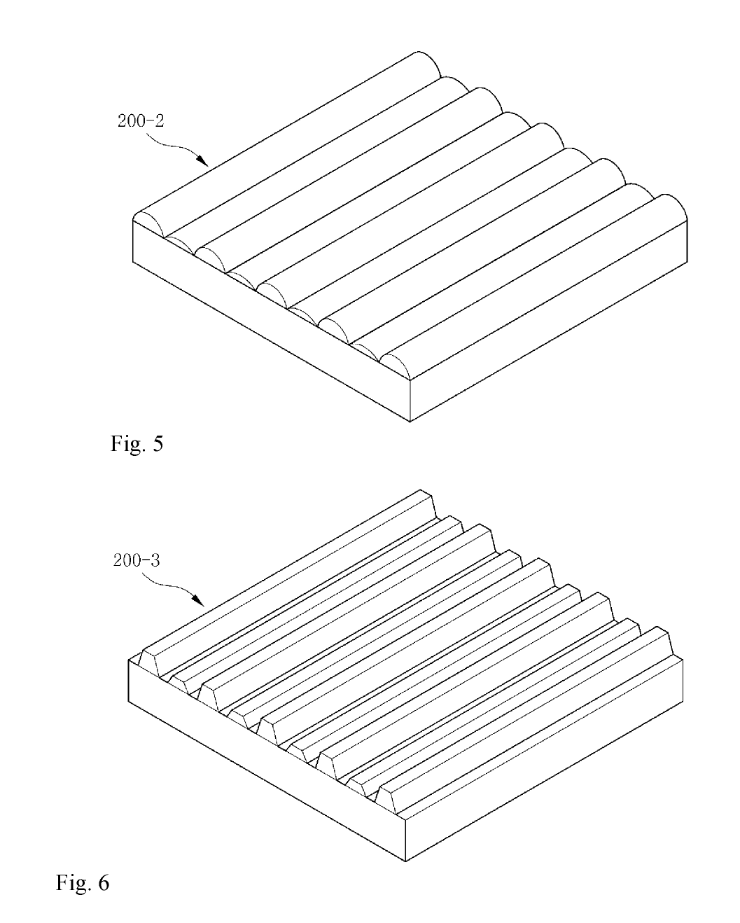

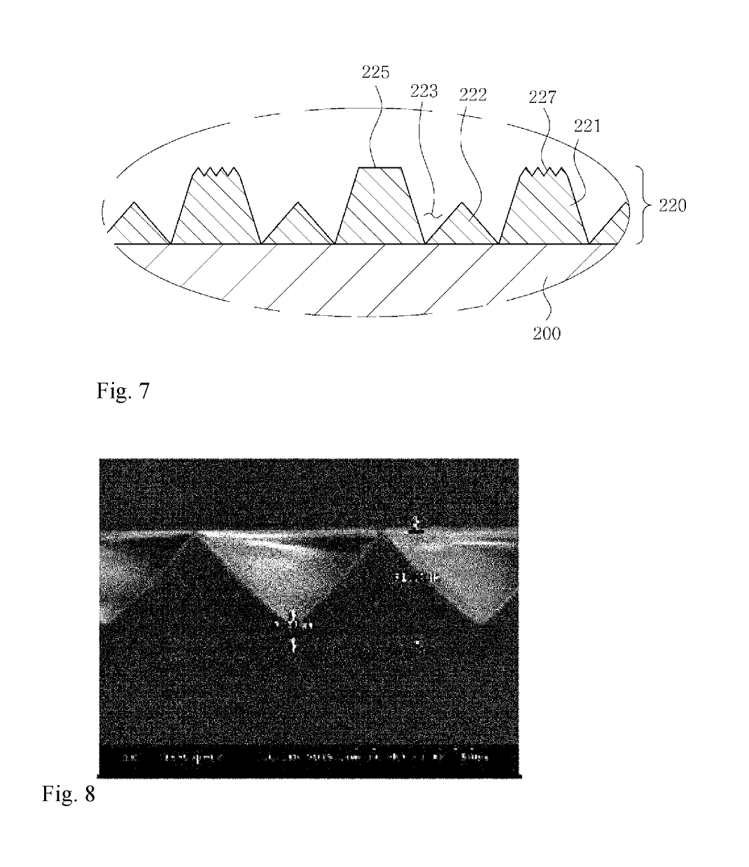

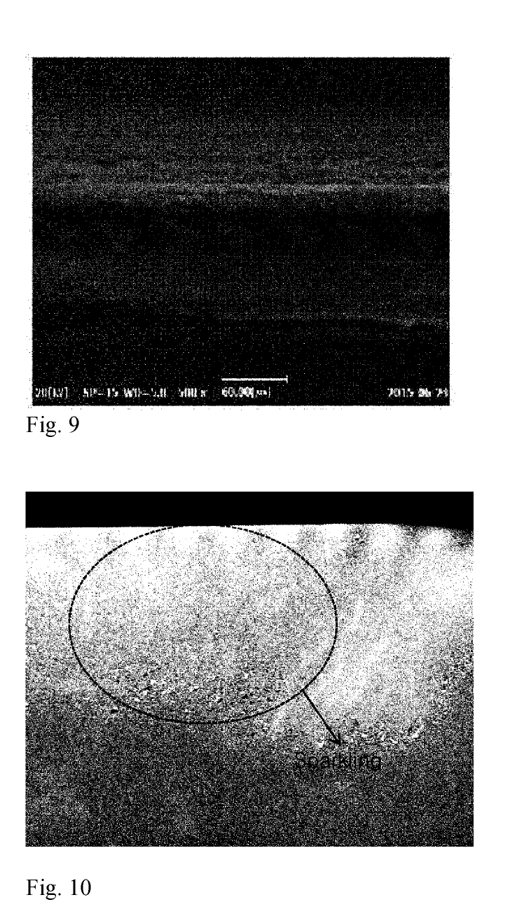

In the accompanying drawings, FIG. 1 is a perspective view illustrating an optical sheet assembly according to an exemplary embodiment of the present invention; FIG. 2 is a cross-sectional view illustrating the optical sheet assembly according to the exemplary embodiment of the present invention; FIGS. 3 and 4 are perspective views illustrating implementations of the first pattern layer in the optical sheet assembly according to the exemplary embodiment of the present invention; FIGS. 5 and 6 are perspective views illustrating implementations of the second pattern layer in the optical sheet assembly according to the exemplary embodiment of the present invention; FIG. 7 is an enlarged cross-sectional view illustrating an important part of another implementation of the second pattern layer in the optical sheet assembly according to the exemplary embodiment of the present invention; FIG. 8 is a tomographic image illustrating an optical sheet according to a comparative example; and FIG. 9 is a tomographic image illustrating an optical sheet according to an example of the present invention.

As illustrated in FIGS. 1 to 7, the optical sheet assembly according to the present exemplary embodiment includes a first base film 100, a second base film 200, and a third base film 300. The first base film 100 has a first pattern layer 110 disposed thereon. The second base film 200 is disposed on one surface of the first base film 100 and has a second pattern layer 220 disposed on the top surface thereof. The second pattern layer 220 abuts and supports the bottom surface of the first base film 100 and is oriented in the same direction as the first pattern layer 110. The third base film 300 is disposed on one surface of the second base film 200, with light-scattering beads being contained therein. The third base film 300 has recesses 310 formed in the surface thereof bonded to the second base film 200. The second pattern layer 220 is oriented in the same direction as the first pattern layer 110. The diameters of the recesses 310 are greater than the diameters of the entrances thereof.

The first base film 100 and second base film 200 are transparent films through which light can pass. It is preferable that each of the first base film 100 and second base film 200 is formed of one selected from polyethersulphone (PES), polyacrylate (PAR), polyetherimide (PEI), polyethylene naphthalate (PEN), polyethylene terephthalate (PET), polyphenylene sulfide (PPS), polyarylate, polyimide, polycarbonate (PC), cellulose triacetate (TAC), and cellulose acetate propinonate (CAP). It is especially preferable that each of the first base film 100 and second base film 200 is formed of polyethylene terephthalate (PET).

The first base film 100 is required to have superior adhesiveness to the first pattern layer 110 and superior transmittance of 90% or higher of light incident to the bottom surface thereof. In addition, the surface of the first base film 100 is required to have uniform smoothness, whereby no brightness variations are caused.

It is also preferable that the thickness of the first base film 100 is in the range of 24 μm to 26 μm. When the thickness of the first base film 100 is less than 24 μm, handling characteristics in fabrication processing are lowered. When the thickness of the first base film 100 exceeds 26 μm, the resultant structure is against the current trend toward thin profiles of LCD modules.

An ultraviolet (UV) adhesive 140 is applied to the bottom surface of the first base film 100. It is preferable that the thickness of the UV adhesive 140 is in the range of 2 μm to 4 μm.

It is preferable that the thickness of the second base film 200 is in the range of 48 μm to 52 μm. When the thickness of the second base film 200 is less than 48 μm, handling characteristics in fabrication processing are lowered. When the thickness of the second base film 200 exceeds 52 μm, the resultant structure is against the current trend toward thin profiles of LCD modules.

The first pattern layer 110 and the second pattern layer 220 are disposed on the top surface of the first base film 100 and the top surface of the second base film 200, respectively, serving to focus light passing through the first base film 100 and the second base film 200 to improve the brightness of light.

In addition, light that has entered from a light guide plate (not shown) may diffuse due to refraction, scattering, scattered reflection, or the like.

In addition, the first pattern layer 110 and the second pattern layer 220 serve to prevent scratches. The first pattern layer 110 and the second pattern layer 220 may be machined using sandblasting, photolithography, or the like.

The first pattern layer 110 and the second pattern layer 220 are machined to have a plurality of protrusions and a plurality of recesses alternating with the protrusions.

The first pattern layer 110 and the second pattern layer 220 allow light to be extracted in the direction perpendicular to an LCD screen.

It is preferable that the height of the protrusions 111 of the first pattern layer 110 is in the range of 14 μm to 16 μm. When the height of the protrusions 111 of the first pattern layer 110 is less than 14 μm, handling characteristics in fabrication processing are lowered. When the height of the protrusions 111 of the first pattern layer 110 exceeds 16 μm, the resultant structure is against the current trend toward thin profiles of LCD modules.

In addition to the protrusions 111 of the first pattern layer 110 having triangular-cross-sections, protrusions 110-2 having semicircular cross-sections or protrusions 110-3 having trapezoidal cross-sections may be employed, as illustrated in FIGS. 3 and 4.

The second pattern layer 220 includes first protrusions 221 abutting and supporting the first base film 100, second protrusions 222 having lower heights than the first protrusions 221, and recesses 223 defined between the first protrusions 221 and the second protrusions 222. Thus, as illustrated in FIG. 2, the second pattern layer 220 includes the taller first protrusions 221 and the shorter, second protrusions 222. This configuration is referred to as a “variable pitch shape.”

The first protrusions 221 abut the bottom portions of the first base film 100 and are bonded to an UV adhesive 240 applied to the bottom surface of the first base film 100. In contrast, the second protrusions 222 are spaced apart from the bottom surface of the first base film 100.

In the configuration in which spaces are defined between the second protrusions 222 and the first base film 100 as described above, when the first base film 100 and the second base film 200 are stacked on and bonded to each other, predetermined portions of the leading ends of the first protrusions 221 penetrate into the UV adhesive 140 applied to the bottom surface of the first base film 100. Due to pressing load, the first base film 100 moves downwards in the space between the leading ends of the second protrusions 222 and the bottom surface of the first base film 100, thereby being able to reduce the thickness of the optical sheet assembly according to the present exemplary embodiment.

As will be described later, the optical sheet assembly according to the present exemplary embodiment can have a slim profile with a thickness of 175 μm, in contrast to a comparative example having a thickness of 185 μm.

The cross-sectional shapes of the first protrusions 221 and the second protrusions 222 of the second pattern layer 220 are selected from among triangular, semicircular, and trapezoidal shapes.

As illustrated in FIGS. 5 and 6, the first protrusions 221 and the second protrusions 222 of the second pattern layer 220 may be implemented as semicircular protrusions 200-2 or trapezoidal protrusions 200-3.

The heights of the semicircular protrusions 200-2 or the trapezoidal protrusions 200-3 may vary to form uneven heights.

As illustrated in FIG. 7, the first protrusions 221 of the second pattern layer 220 may have planar portions 225 on the top portions thereof to increase bonding areas.

In addition, a plurality of minute projections 227 may be formed on the planar portions 225 to increase bonding force.

The formation of the second pattern layer 220 leads to an anti-blocking characteristic. The term “blocking” generally refers to a phenomenon in that the inner surfaces of films tend to stick to each other. The second pattern layer 220 disposed on the top surface of the second base film 200 can prevent the second base film 200 from sticking to the first base film 100, i.e. can prevent blocking between the first base film 100 and the second base film 200.

Blocking not only obstructs processing but also leads to the formation of interference fringes.

Thus, the second pattern layer 220 allows light to diffuse while preventing blocking.

The third base film 300 is a transparent film formed of PET, through which light can pass. The third base film 300 has a diffusion layer 320 on one surface thereof, the diffusion layer 320 serving to diffuse light before introduction into the second base film 200.

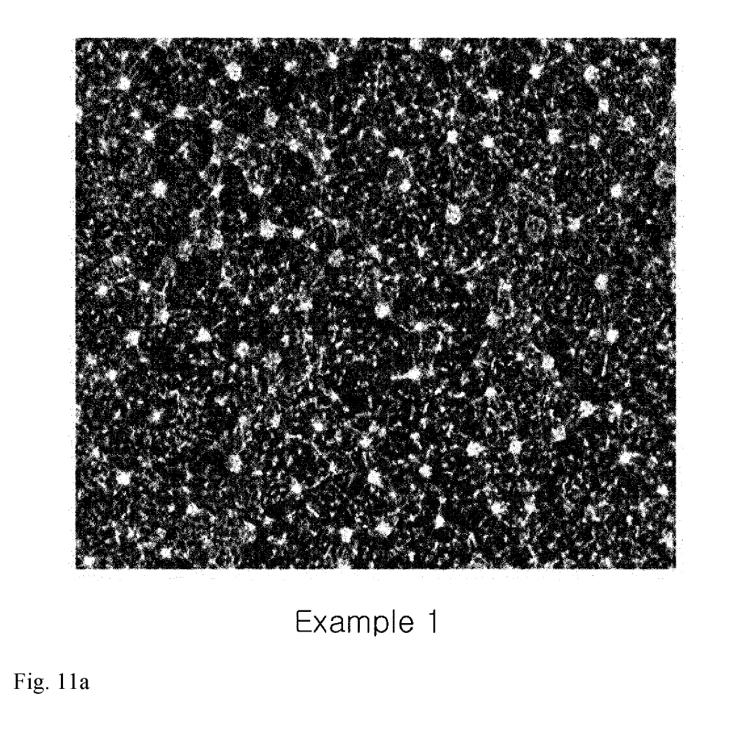

The diffusion layer 320 formed on one side of the second base film 200 includes light-scattering beads contained therein. The diffusion layer 320 is disposed on one surface of the third base film 300 that is bonded to the second base film 200. The recesses 310 are formed in the diffusion layer 320, as illustrated in FIGS. 1 and 2. The diameters of the recesses 310 are greater than the diameters of the entrances thereof. The recesses 310 serve to prevent or reduce sparkling caused by an adhesive component bonding the third base film 300 having the diffusion layer 320 and the second base film 200. The sparkling formed by the adhesive component is illustrated in FIG. 10.

In addition, the diffusion layer 320 includes a binder resin and beads contained in the binder resin. It is preferable that the diffusion layer 320 is formed by mixing 10 to 50 weight fraction of the beads with 100 weight fraction of the binder resin.

It is preferable that the binder resin is formed of one of a UV curable epoxy binder or a UV curable binder containing silicone. It is more preferable that the binder resin is formed of a terpolymer of tris(2-acryloxyethyl)isocyanurate-2-propenoic acid, (1-methlyethyliden)bis(4,1-phenyleneoxy-2,1-ethanediyloxy-2,1-ethanediyl)ester, and 1-hydroxy-cyclohexyl-phenyl ketone. The terpolymer may be a block copolymer or a random copolymer, with a glass transition temperature thereof being about 52° C. and a number-average molecular weight thereof being about 4500.

The particle sizes of the beads used herein are in the range of 1.5 μm to 5 μm. The beads are formed as a layer having a predetermined thickness in the top portion of the diffusion layer 320. The beads having this range of particle sizes serve to minimize the bonding area of the UV adhesive used in the process of bonding the third base film and the second base film, thereby preventing optical loss, and reduce sparkling due to the refraction of light by the adhesive.

Here, it is preferable that the beads are formed of polymethylmethacrylate (PMMA) or poly-n-buthyl-methylacrylate (PBMA).

When the content of the beads is less than 10 weight fraction, the light diffusing effect of the diffusion layer 320 is reduced. When the content of the beads exceeds 50 weight fraction, the mechanical properties of the diffusion layer 320 may be significantly degraded by excessively high content of the beads while the light diffusing effect of the diffusion layer 320 is not significantly improved.

In addition, the third base film 300 has a bead coating layer 340 formed on the bottom surface thereof.

The bead coating layer 340 includes a binder resin and bead particles contained in the binder resin.

It is preferable that the binder resin is formed of one of a UV curable epoxy binder or a UV curable binder containing silicone. It is more preferable that the binder resin is formed of a terpolymer of tris(2-acryloxyethyl)isocyanurate-2-propenoic acid, (1-methlyethyliden)bis(4,1-phenyleneoxy-2,1-ethanediyloxy-2,1-ethanediyl)ester, and 1-hydroxy-cyclohexyl-phenyl ketone. The terpolymer may be a block copolymer or a random copolymer, with a glass transition temperature thereof being about 52° C. and a number-average molecular weight thereof being about 4500.

It is preferable that the thickness of the bead coating layer 340 is in the range of 2 μm to 4 μm. When the thickness of the bead coating layer 340 is less than 2 μm, handling characteristics in fabrication processing are lowered. When the thickness of the bead coating layer 340 exceeds 4 μm, the resultant structure is against the current trend toward thin profiles of LCD modules.

Hereinafter, the process in which light passes through the optical sheet assembly having the above-described configuration according to the present exemplary embodiment will be described.

First, light that has been generated by a light source (not shown) is guided by a light guide plate (not shown) to enter the third base film 300. Then, the light is first diffused by the bead coating layer 340 and the diffusion layer 320.

In addition, the light is re-diffused by the beads contained in the bead coating layer 340 and the diffusion layer 320 to enter the second base film 200 at a uniform level of distribution.

Afterwards, the light is focused by the second pattern layer 220 while passing through the second base film 200, such that the brightness of the light is increased. Then, the light having the increased brightness enters the first base film 100.

Thereafter, the light is focused by first pattern layer 110 while passing through the first base film 100, such that the brightness of the light is increased. Then, the light having the increased brightness is extracted upwards.

The extracted light enters an LCD screen to illuminate the LCD screen.

An example in which the characteristics of the optical sheet assembly having the above-described configuration according to the present exemplary embodiment were tested is illustrated in FIGS. 8 and 9.

FIG. 8 is a cross-sectional view and tomographic image illustrating an optical sheet according to a comparative example to be compared with an example of the present invention. The comparative example is a product of another company, with a product name “XLAS200JM7.” The optical sheet according to the comparative example is formed by stacking two layers of base films on each other, in which each layer has a pattern layer.

The thickness of the optical sheet is 185 μm, and the luminance of the optical sheet is 100.00%.

FIG. 9 is a tomographic image illustrating an optical sheet according to an example of the present invention.

In the optical sheet according to the example of the present invention, a second pattern layer 220 appears in the middle portion. The thickness of the optical sheet is 175 μm, and the luminance of the optical sheet is 101.00%.

Thus, it can be appreciated that the thickness of the example of the present invention was reduced to be smaller than that of the comparative example, while the luminance of the example of the present invention was increased to be higher than that of the comparative example.

Hereinafter, the physical properties of the optical sheet according to the present invention will be described with reference to Examples.

### EXAMPLE 1

An optical sheet assembly including a first base film, a second base film formed on one side of the first base film, and a third base film formed on one side of the second base film was fabricated. Here, the first base film was formed of PET, to a thickness of 25 μm, with a first pattern layer having a thickness of 15 μm being formed thereon. The second base film was formed of a UV adhesive, to a thickness of 25 μm, with a second pattern layer (having a thickness of 14 μm to 16 μm) being formed on the top surface of the second base film to abut and support the bottom surface of the first base film. The third base film was formed of a UV adhesive, to a thickness of 120 μm, with recesses having a depth 20 μm being formed in a surface that is bonded to the second base film. The third base had a diffusion layer (formed of 100 weight fraction of tris(2-acryloxyethyl)isocyanurate-2-propenoic acid and 30 weight fraction of PMMA beads) in which light-scattering beads were contained. The second pattern layer was oriented in the same direction as the first pattern layer, and the diameters of the recesses were greater than the diameters of the entrances thereof.

### Comparative Example 1

The optical sheet assembly illustrated in FIG. 8 (product name: XLAS200JM7)

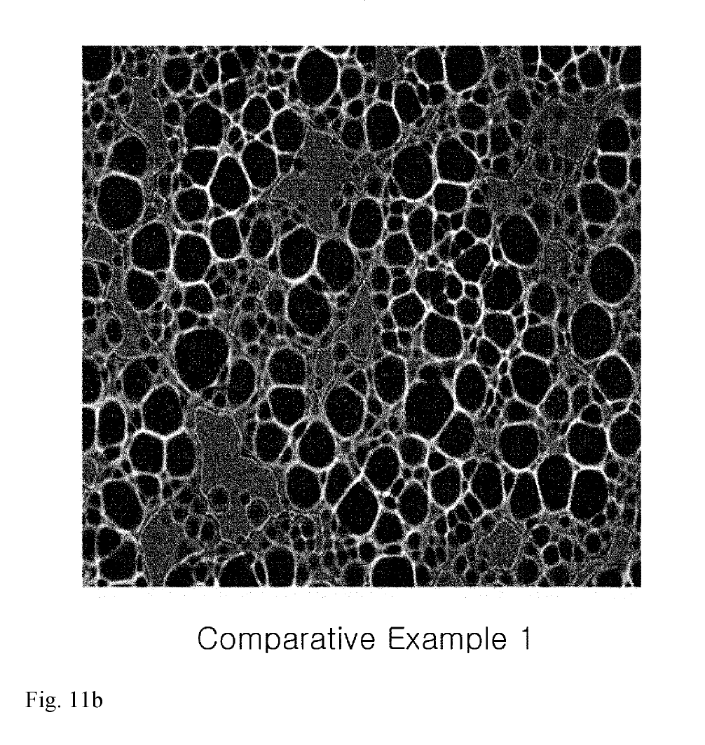

FIGS. 11A and 11B are scanning electron microscopy (SEM) images of sparkling occurring in an optical sheet assembly according to Example 1 of the present invention and an optical sheet assembly according to Comparative Example 1.

As illustrated in FIGS. 11A and 11B, it can be appreciated that sparkling in the optical sheet assembly fabricated according to Example 1 of the present invention was significantly reduced compared to the optical sheet assembly fabricated according to Comparative Example 1.

In addition, the brightness of the optical sheet assemblies according to Example 1 of the present invention and Comparative Example 1 were measured three times and average values thereof were represented in Table 1.

(Here, the brightness of the optical sheet assemblies was measured using a brightness meter.)

TABLE 1

| | Example 1 | | | Comparative Example 1 | | |
|---|---|---|---|---|---|---|
| Category | X | Y | Brightness | X | Y | Brightness |
| #1 | 0.2618 | 0.2848 | 9096.00 | 0.2633 | 0.2891 | 8647.00 |
| #2 | 0.2619 | 0.2847 | 9096.00 | 0.2635 | 0.2883 | 8609.00 |
| #3 | 0.2619 | 0.2847 | 9096.00 | 0.2634 | 0.2883 | 8609.00 |
| Average | 0.2619 | 0.2847 | 9096.00 | 0.2634 | 0.2886 | 8621.67 |

As represented in Table 1 above, it can be appreciated that the brightness of the optical sheet assembly fabricated according to Example 1 of the present invention was significantly improved compared to the brightness of the optical sheet assembly fabricated according to Comparative Example 1.

Therefore, in the optical sheet assembly according to the present invention, the pattern layers having the shape of concave and convex portions are machined in the top surfaces of the first and second base films having the shape of dual layers, such that a light-diffusing effect can be obtained without a light-diffusing layer in which a light-diffusing agent is contained. This can consequently reduce the number of components while reducing the thickness of the multilayer optical films. In addition, the recesses having diameters greater than the diameters of the entrances are formed in the third base film, thereby being able to prevent or reduce sparkling.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. An optical sheet assembly comprising:
a first base film having a first pattern layer disposed thereon;
a second base film disposed on one surface of the first base film, the second base film having a second pattern layer disposed on a top surface thereof, the second pattern layer abutting and supporting a bottom surface of the first base film; and
a third base film disposed on one surface of the second base film, the third base film having light-scattering beads being contained therein and recesses formed in a surface thereof bonded to the second base film,
wherein the second pattern layer is oriented in a same direction as the first pattern layer, and
wherein diameters of the recesses are greater than diameters of entrances thereof.

2. The optical sheet assembly according to claim 1, wherein the first pattern layer comprises a plurality of protrusions and a plurality of recesses defined between the protrusions.

3. The optical sheet assembly according to claim 1, wherein the second pattern layer comprises first protrusions abutting to and supporting the first base film, second protrusions, heights of which are smaller than heights of the first protrusions, and recesses defined between the first protrusions and the second protrusions.

4. The optical sheet assembly according to claim 2, wherein heights of the protrusions of the first pattern layer range from 14 μm to 16 μm.

5. The optical sheet assembly according to claim 1, wherein the first base film is formed of polyethylene phthalate.

6. The optical sheet assembly according to claim 1, wherein a thickness of the first base film ranges from 24 μm to 26 μm.

7. The optical sheet assembly according to claim 1, wherein the first base film comprises an ultraviolet adhesive applied to a bottom surface thereof.

8. The optical sheet assembly according to claim 7, wherein a thickness of the ultraviolet adhesive ranges from 2 μm to 4 μm.

9. The optical sheet assembly according to claim 4, wherein the protrusions have a cross-sectional shape selected from the group consisting of triangular, semicircular, and trapezoidal shapes.

10. The optical sheet assembly according to claim 1, wherein the second pattern layer comprises first protrusions and second protrusions having cross-sectional shapes selected from the group consisting of triangular, semicircular, and trapezoidal shapes.

11. The optical sheet assembly according to claim 10, wherein top ends of the second protrusions of the second patter layer are spaced apart from a bottom portion of the first base film.

12. The optical sheet assembly according to claim 10, wherein the first protrusions of the second pattern layer have planar portions on top ends thereof to increase bonding areas.

13. The optical sheet assembly according to claim 12, wherein a plurality of minute projections are formed on the planar portions to increase bonding force.

14. The optical sheet assembly according to claim 1, wherein the second base film is formed of polyethylene phthalate, a thickness of the second base film ranging from 48 μm to 52 μm.

15. The optical sheet assembly according to claim 1, wherein the second base film comprises an ultraviolet adhesive applied to a bottom surface thereof, a thickness of the ultraviolet adhesive ranging from 2 μm to 4 μm.

16. The optical sheet assembly according to claim 1, wherein the third base film comprises a diffusion layer on one surface thereof, the diffusion layer diffusing light before the light enters the second base film.

17. The optical sheet assembly according to claim 16, wherein the diffusion layer comprises a binder resin and beads contained in the binder resin.

18. The optical sheet assembly according to claim 17, wherein the beads are formed as a layer having a predetermined thickness in a top portion of the diffusion layer and abut to a bottom surface of the second base film.
